(19) United States
(12) Patent Application Publication
(10) Pub. No.: US 2014/0030560 A1
(43) Pub. Date: Jan. 30, 2014

(54) BATTERY WITH SOLID STATE COOLING

(71) Applicants: Leonid C. Lev, West Bloomfield, MI (US); Gregory P. Meisner, Ann Arbor, MI (US); Nikolay Kondratyev, West Bloomfield, MI (US)

(72) Inventors: Leonid C. Lev, West Bloomfield, MI (US); Gregory P. Meisner, Ann Arbor, MI (US); Nikolay Kondratyev, West Bloomfield, MI (US)

(73) Assignee: GM GLOBAL TECHNOLOGY OPERATIONS LLC, Detroit, MI (US)

(21) Appl. No.: 13/557,419

(22) Filed: Jul. 25, 2012

(51) Int. Cl. H01M 10/48; H01M 10/50

(52) U.S. Cl. 429/72; 429/120; 429/90

(57) ABSTRACT

A battery is provided with solid state cooling means so that it may operate within a predetermined operating temperature range is described. Suitably such a battery may be a high voltage-high current battery intended for use in a vehicle propelled by an electric motor such as a hybrid or electric vehicle. A plurality of thermoelectric assemblies is positioned in thermal contact with the assembled cells and/or modules which comprise the battery. These assemblies may be appropriately powered to pump heat from the battery responsive to a plurality of temperature sensors associated with individual cells or modules so that the battery temperature is maintained within the predetermined temperature range. The thermoelectric assemblies may also be powered to pump heat to the battery to more rapidly increase its temperature to the predetermined operating range under low temperature conditions.

### TECHNICAL FIELD

This disclosure pertains to cooling batteries, particularly high voltage-high current batteries comprised of an in-line assembly of a plurality of up-standing, like-shaped, modules of assembled cells, suitable for use in electric or hybrid vehicles exposed to a wide range of ambient temperatures. More specifically, this disclosure pertains to the use of relatively thin, plate-like assemblies of interconnected solid state, thermoelectric devices, the assemblies being shaped like the modules and placed between selected modules for heating or cooling them to maintain them in a predetermined operating temperature range.

### BACKGROUND OF THE INVENTION

The statements in this section merely provide background information related to the present disclosure and may not constitute prior art.

There is increasing interest in battery-powered electric vehicles. These vehicles may be pure electric vehicles in which the sole source of power is a battery, or hybrid vehicles in which an electric propulsion system is supplemented by an on-vehicle internal combustion or IC engine.

Batteries for such vehicles are typically assembled from a plurality of individual cells appropriately interconnected in series and parallel to develop a suitable voltage and electrical storage capability for their intended application. Most commonly individual cells are first assembled into smaller groupings, called modules, and then a number of modules is appropriately interconnected and packaged to produce the battery. Often, the electrode, electrolyte, and separator elements of the individual cells are prepared in the form of relatively thin rectangular shapes (or other suitable shapes). A grouping of such cells is often assembled and electrically connected to provide a predetermined electrical potential and current capacity. This grouping may be contained in a soft polymer pouch. And several pouches may be assembled and interconnected as a module and contained in a plastic or metal container.

For example one electric vehicle with a 24 kWh battery employs 192 soft-sided Li-ion cells each capable of producing about 3.8 volts. These cells are assembled into the battery under the following scheme. Two of these cells, connected in parallel, are series connected to a second pair of parallel-connected cells and packaged into a hard-cased module developing about 7.6 volts. In turn, 48 of these modules are then connected to develop the nominally 360 volt battery. The modules alone occupy about 4 cubic feet and when packaged with associated equipment such as control electronics may require a footprint of about 3 feet by 2 feet in a vehicle.

In both electric and hybrid vehicles, the batteries operate at high voltages and are designed to deliver high currents during operation and to accept high current inputs during battery charging. Since all batteries exhibit internal resistance, appreciable resistance heating may occur internal to the battery during these high current events. The heat generated, if not dissipated outside the battery, may elevate the battery temperature and stress some of the battery components.

Generally such batteries are intended for use at temperatures ranging from about −30° C. to about 40° C. with a preferred operating range of between 25° C. and 35° C. Even a relatively modest increase in battery operating temperature to 70° C. or so runs the risk of degrading battery performance.

To maintain the preferred battery operating temperature, most battery-powered electric vehicles include some provision for battery cooling. Such cooling may consist of a single system globally applied to the entire battery, or of a plurality of cooling units distributed throughout the battery. Such cooling systems may employ liquid cooling necessitating one or more pumps and extensive piping to ensure adequate coolant flow to all cooling units in the battery. It will also be appreciated that a battery with a large footprint will require significant volumes of coolant. The battery coolant circulatory system and the coolant itself both add mass to electric vehicles, diminishing their range and reducing their appeal to potential purchasers.

There is therefore continuing interest in a battery cooling system offering good performance without adding significant mass or volume to the battery.

### SUMMARY OF THE INVENTION

A high voltage battery for a traction motor in a vehicle is often assembled from a plurality of lower voltage modules. These modules are composed of a substantially rigid closed housing each of which contains several individual battery cells tightly packed into the housing for volume efficiency. Modules typically employ a common design. And they, in their turn are designed and intended to assemble into a compact, space-efficient assembly. The closely-packed cells in each module are individually packaged and often contained in a flexible polymer-walled pouch, generally rectangular in outline and sealed at the pouch edges. In the case of lithium ion batteries such a cell is termed a soft prismatic lithium ion cell.

Modules are generally also rectangular in plan view and the housing typically comprises two closely-spaced, opposing and co-extensive rectangular faces sealed with a narrow strip of material extending around the perimeter of the faces to seal the housing and fully contain the cells. A battery is assembled by stacking a plurality of such like sized and shaped module housings in face-to-face relation and appropriately electrically interconnecting the respective terminals of the modules so that the assembled battery may deliver electrical energy at a pre-determined voltage and current.

Modules of such a high current, high voltage battery may be maintained in a pre-determined temperature range by integrating thermoelectric assemblies comprising thermoelectric elements into the battery. The thermoelectric assemblies may be integrated with the modules, particularly the module housings, or with the cells within the modules, particularly the cell pouch walls. Thermoelectric elements are solid-state devices which may be shaped with flat, parallel opposing faces. When the opposing faces of a device are connected to a direct current (DC) electrical source, the device develops a temperature gradient between its faces. This temperature gradient may be exploited as described herein to heat or cool modules of an assembled battery.

The thermoelectric elements may be in the form of relatively thin square or rectangular bodies prepared from n-doped and p-doped semiconductors and terminating, at their ends, in opposed, electrically-interconnected faces. A grouping of such elements, of like or complementary shape, may be assembled in plate-like arrangements for placement of heating and cooling bodies between modules or cells of a battery.

Because such thermoelectric elements will, in passing electric current, develop an elevated temperature on one face and a reduced temperature at their opposing face this behavior may be exploited to heat or cool a body in thermal contact with the thermoelectric elements. The locations of the hot and cold faces may be reversed by reversing the direction of current flow so that a single element or group of elements may serve to both heat and cool the body.

As noted, frequently such thermoelectric elements are combined into assemblies in which the n-type and p-type thermoelectric elements are connected electrically in series and thermally in parallel to provide enhanced thermal capacity. Commonly the faces of the thermoelectric elements and their electrical interconnects are sandwiched between two electrically non-conductive substrates, often fabricated of ceramic. These substrates provide mechanical support for the assembly, but impede heat flow.

In a module embodiment, the thermoelectric assemblies may incorporate an array of cuboids of bulk thermoelectric semiconductors. The array is generally coextensive with the module housing face and may employ the module housing face as a substrate or support. In this embodiment the thermoelectric assembly may be adhesively bonded to the module housing face. Utilizing the module housing face as a support eliminates the need for at least one of the non-conductive, ceramic substrates commonly used to support the assembly, enabling improved heat flow and thereby enhancing the capabilities of the thermoelectric assembly.

In an alternative, and yet more effective, embodiment the thermoelectric elements may be embedded, or partially embedded, in the module wall. Such an approach is feasible only for module containers made of polymer or similarly non-conductive materials. But by embedding the thermoelectric elements in the wall, the first face or end of the thermoelectric elements will be positioned in yet closer proximity to the cell pouches which are the source of any heating. Hence resistance to heat flow induced by the wall will be reduced in proportion to the extent of embedment and the resulting wall thickness under the thermoelectric elements. It will be appreciated that the cells within the module housing are contained within pouches and that the pouch walls contain and isolate the cell electrodes and electrolyte. Hence, the thermoelectric assembly and its associated electrodes are not precluded from extending to the interior surface of the module housing wall. Those skilled in the art of polymer molding will appreciate that well-known overmolding techniques may be employed to achieve the requisite degree of embedment.

Similar reasoning suggests that eliminating the second electrically non-conductive substrate on the second or opposing ends or faces, that is the ends or faces not in contact with the module wall, would also be effective in enhancing heat transfer. Elimination of the second substrate would require that the thermoelectric assembly support itself. But the thermoelectric elements are rigid and relatively short, 5 millimeters or less in extent, so an assembly well secured to the rigid housing face at its first end will be adequately supported. However, where circulating fluid is used to carry off or convey heat to or from the thermoelectric elements, a substrate which allows passage of fluid across both surfaces may enhance heat transfer. Further, by appropriate design of an opposing substrate, for example by incorporating fins, heat transfer from the second surface to a fluid in contact with the second surface may be enhanced. Thus the thermoelectric element-contacting surface of a second, rigid substrate should be substantially planar but its opposing surface may be shaped to optimize heat transfer to a fluid flowing over the substrate. Such features, including fins, pins or other protrusions are well known to those skilled in the art.

The second surface of the substrate may also be adapted to engage a second surface of a second substrate of an abutting thermoelectric assembly to at least contribute to securely binding assemblies and modules together.

Embedment of the thermoelectric assembly is only feasible for polymer or other electrically non-conductive module housings. Embedment may be achieved using conventional over-molding techniques. These techniques may require fixturing the assembly to provide temporary support to the assembly during flow of polymer into the mold. If the thermoelectric assembly is to be attached to the housing face, differing approaches may be required for electrically conducting and non-conducting faces. Attachment of the thermoelectric assembly to a module housing face or to a second substrate with a non-electrically conducting polymer wall may be made using adhesive only. Suitable adhesives include silicone and acrylic. Proper functioning of the thermoelectric device requires an organized and orderly flow of current through the device. Thus a thermoelectric assembly must be electrically isolated when attached to an electrically conductive surface such as a metal or metal-faced module housing. Similar considerations apply if the second substrate is electrically conductive. In all of these circumstances attachment may be effected using a thin, electrically insulating polymer sheet with adhesive on both sides. A polyimide sheet (commonly known as Kapton®), 13 or 25 micrometers thick, offers suitable electrical properties, and may be obtained with both silicone and acrylic adhesives at thicknesses of about 20 micrometers per side. The polyimide sheet provides sufficient electrical isolation between the thermoelectric assembly and the electrically-conducting module housing face or second substrate. Of course such an adhesive sheet may also be employed on non-conducting bodies.

Any suitable number of such thermoelectric assemblies as required to maintain the battery temperature in its preferred operating range may be inserted between and interleaved with the battery modules or the cell pouches. Placement of the thermoelectric assemblies may be uniform throughout the battery or selectively applied to only those battery locations most prone to overheat. The thermoelectric elements may include bismuth-containing semiconductor compositions such as Bi₂Te₃ (bismuth telluride) and Bi₂Se₃ (bismuth selenide) among others.

The thermoelectric assemblies may be fabricated of assembled bulk elements or of elements fabricated in situ using thin film deposition techniques, for example, vapor deposition. Such in situ fabrication is most commonly used in the cell pouch wall embodiment in which the thermoelectric elements may have their opposing faces spaced apart by only 100 or 200 micrometers or so.

These thermoelectric assemblies may be used as controllable heat pumps to thermally manage the battery. By placing such thermoelectric assemblies in thermal contact with module housing faces and controlling the magnitude and direction of current flow, heat may be extracted or supplied to the battery as required. Thus, a cold battery may be more rapidly elevated to its preferred operating temperature and a hot, or over-temperature battery more rapidly cooled to maintain its temperature in a preferred operating range.

Because the thermoelectric elements and their electrical interconnections are directly attached to the cell pouch or module housing wall, the thermal resistance and associated temperature gradients associated with the substrate may be eliminated. Thus, the module housing face serves a dual purpose, containing the individual cells while also serving as one substrate for the thermoelectric assembly, and thereby integrating the thermoelectric assembly with the battery module.

The temperature developed in even nominally identical battery cells and modules may vary. The thermoelectric elements may also serve as temperature sensors, monitoring the battery cell or module temperature. Data acquired during short periods when the thermoelectric elements are unpowered may be analyzed to extract the cell or module temperature. Since each cell or module is in thermal contact with a plurality of thermoelectric elements arranged on a cell or module surface it is feasible to spatially map the temperature in the cell or module. So for each module subject to such thermoelectric cooling it is preferred to adjust the operating conditions of its thermoelectric assembly individually. Of course, temperature may also be measured using dedicated temperature sensors such as thermocouples or thermistors embedded or incorporated in cells or modules.

Responsive to the measured temperature of each module, a controller may adjust the polarity and magnitude of the current flow through the thermoelectric assembly according to some suitable algorithm to maintain the module temperature, and hence the overall battery temperature, in its preferred range. Each module may be controlled by a dedicated controller, but in view of the relatively small number of units to be controlled, multiplexing may be employed so that a single controller samples each sensor and appropriately adjusts the current applied to thermoelectric assembly every few seconds or so. Such frequent adjustment of the operating condition of the thermoelectric devices is consistent with the relatively long (on the order of seconds or tenths of seconds) time-frame over which a module temperature may change.

The heat added or removed from the battery and its constituent components may be transferred from the module and conveyed across the thickness of the thermoelectric assembly to that face not in contact with the battery. This heat may be removed by convection by passing a fluid medium across the second surface of the substrate attached to the opposing faces of the thermoelectric elements. Preferably air cooling may be used but liquid cooling, using lower coolant volume than conventional approaches may also be employed, provided the coolant is electrically non-conductive or electrically isolated from the thermoelectric assembly.

Convective air cooling may be employed, particularly if the cooling channels are arranged for vertical flow of air, but, more typically, forced air cooling will be preferred. Such forced air cooling may be achieved using a plurality of fans. But, more preferably, only a single fan may be used. Such a single fan may draw in ambient air from outside the vehicle and direct it into a manifold comprising a plurality of ducts so arranged to convey cooling air across each of the thermoelectric assemblies. Preferably the fan is powered by an electric motor so that the controller may adjust the fan motor power in proportion to the battery temperature. It is preferred to maintain the cold ends of the thermoelectric elements at near-ambient temperature, preferably within about 5° C. of ambient temperature. Ambient temperature is the temperature of the area or environment surrounding a vehicle. A suitable operating range of ambient air temperatures may extend from about −30° C. to about 35° C. Suitable algorithms, based on experimentation, theory or modeling, may be developed to correlate battery temperature and the required fan motor speed to achieve the desired thermoelectric element cold end temperature.

When implemented under closed loop control such a system may be operated as follows for a vehicle in use:
a) measure, when the battery is powering a load, the battery temperature and compare the measured battery temperature to a preferred battery temperature range; and
b) if the battery temperature is within the preferred battery range repeat step a); or
c) if the battery temperature is outside the preferred range, apply, in a suitable direction, a suitable direct current flow to modify the battery temperature such as to bring the battery temperature into its preferred operating range so as to heat a cold battery or cool a hot battery; and
d) repeat steps a) through c) for as long as the battery is powering the load.

There are climactic conditions where the battery temperature may exceed its preferred range even when parked. Under desert conditions excessive battery temperatures may obtain due to high solar loads and high ambient temperatures. In extremely cold climates the battery temperature may fall below its preferred minimum temperature. In these circumstances an analogous control strategy may be followed even though the traction battery is not in use.

In a second embodiment, the thermoelectric elements and their associated electrical interconnects may be attached to individual cells. The wall of the flexible polymer pouch of the cell is often of multi-layer construction and may incorporate several sheet polymers bonded together into a composite sheet less than 300 micrometers thick. The outer layer, to which the thermoelectric elements and associated interconnects may be attached is often non-electrically conducting Polyethylene Terephthalate (PET).

Attachment of the thermoelectric assembly to the pouch wall may be made using adhesive only. Because PET is a low surface energy polymer achieving a strong adhesive bond may necessitate a chemical or plasma pre-treatment prior to application of the adhesive. Attachment of the opposing end of the assembly to a non-electrically conducting second substrate may likewise be made using adhesive only. Use of a metallic or electrically-conducting substrate will necessitate bonding using a thin, electrically insulating polymer sheet with adhesive on both sides. Again, a suitable choice may be a polyimide sheet (commonly known as Kapton®), 13 or 25 micrometers thick, with both silicone and acrylic adhesives at thicknesses of about 20 micrometers per side.

For pouches, a second rigid substrate is required to ensure that flexure of the pouch wall does not result in contact and electrical short-circuits between adjacent thermoelectric elements. The rigid substrate will serve to enforce separation between adjacent thermoelectric elements and interconnects. Thus deflections and displacements occurring in the flexible pouch wall substrate are not transmitted to the elements. If further reinforcement is required the thermoelectric elements may be encapsulated in a suitable, electrically non-conductive material such as an epoxy.

In a third embodiment the thermoelectric elements may be integrated into the cell walls. This may be most readily accomplished by depositing the thermoelectric compositions but thin bulk elements may also be used. Typically a cell wall consists of stacked layers of polymer sheet material bonded to one another. A suitable inner polymer, in contact with the cell electrolyte, is polypropylene at a thickness approaching 100 micrometers. This is typically overlaid with nylon, several tens of microns thick, which in its turn is overlaid with the previously-described layer of PET, again in a thickness or several tens of microns. When integrated into the cell walls the thermoelectric devices are placed in contact with the polyethylene layer, suitably interconnected electrically and overlaid with the nylon and PET layers. In this embodiment the thermoelectric elements may be extensive in one dimension so that the p-n combination may have the form of a rib. Suitably such ribs may be laterally displaced from one another on abutting cells to form channels for passage of cooling fluid.

Other objects and advantages of the invention will be apparent from a detailed description of various embodiments of the invention.

### BRIEF DESCRIPTION OF THE DRAWINGS

FIG. 1A schematically illustrates, in perspective view, a plurality of battery modules arranged into a battery. The battery incorporates an inlet, an outlet and internal passages (not visible) for circulation of fluid through the battery. FIG. 1B shows, in layered cutaway, battery pouches contained in a battery module, the module wall having a thermoelectric assembly consisting of thermoelectric elements and electrical interconnects.

FIG. 2A schematically illustrates, in perspective view, a thermoelectric assembly suitable for practice of the invention. A comparative example of a commercial thermoelectric device is illustrated in FIG. 2B.

FIG. 3A schematically illustrates, in cross-section, two configurations of a thermoelectric assembly in thermal contact with a battery module for control of module temperature. In one embodiment the battery module wall 56′ is a moldable polymer. In a second embodiment module wall 56 is a metal. FIGS. 3B and 3C show details of the attachment of the thermoelectric elements and associated electrodes to the module walls in the embodiment where the module wall is a metal.

FIG. 4 shows, in cross-section the contact formed between two adjacent battery module units substantially as shown in FIG. 3A with features for releasably attaching the battery modules together and incorporating a split-apart busbar for delivery of electrical current to the thermoelectric assemblies.

FIG. 5 shows in fractional perspective view a soft-sided pouch incorporating embedded thermoelectric elements.

FIG. 6 shows in fractional perspective view two soft-sided pouches with embedded thermoelectric elements as shown in FIG. 5 in face to face engagement illustrating the manner in which they engage to form fluid circulation passages.

FIG. 7 shows, in fractional perspective view another embodiment of a soft-sided pouch with embedded thermoelectric elements and incorporating integral fluid circulation passages.

FIG. 8 shows a representative control scheme for control of a battery cell or module temperature.

### DESCRIPTION OF PREFERRED EMBODIMENTS

The following description of the embodiment(s) is merely exemplary in nature and is not intended to limit the invention, its application, or uses.

Although high power batteries, such as Li-ion batteries used in hybrid or electric vehicles, may be exposed to ambient temperatures of from about −30° C. to about 40° C., it is preferred to operate such batteries at between about 25° C. and about 35° C. High temperatures are particularly problematic since temperatures much in excess of this range may reduce battery life and performance.

To assure operation in this preferred temperature range, most such high power, high voltage batteries incorporate some provision for managing battery temperature, primarily for cooling the battery during operation under conditions of sustained high power demand. Commonly, active cooling is preferred and a suitable fluid may be circulated through and around the battery. The coolant may be water-based with appreciable concentrations of additives, for example, to prevent or reduce corrosion and inhibit algae growth, among others. Because a high voltage battery may include a plurality of individual cells and occupy a volume of several cubic feet, distributing the cooling fluid throughout the body of battery may require extensive flow channels and a considerable volume of coolant. These requirements may increase the overall vehicle volume devoted to battery storage and add considerably to the overall in-service battery mass.

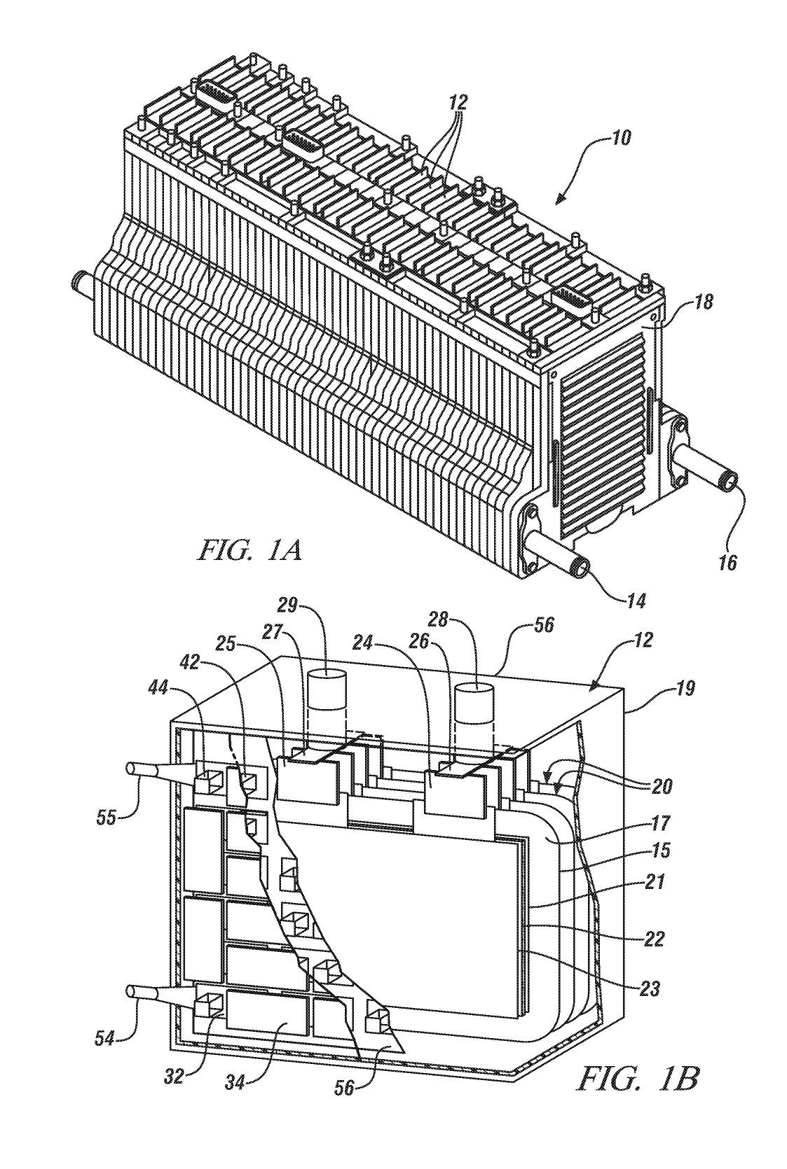

An example of a battery 10 is shown in FIG. 1. In this exemplary embodiment a plurality of stacked and interconnected modules 12 is secured by mounting frame 18. Battery 10 incorporates provision for circulation of fluid fed by inlet 14 and terminating at outlet 16. With suitable gasketing, fluid entering the module stack at inlet 14 under the urging of a pump (not shown), may be distributed along the length of the stack without leakage. In like manner to the inlet flow, the outlet flow is confined within the battery volume and exhausted from battery outlet 16. Circulation may be closed-loop or open loop. In a closed-loop system, typically used with liquids, fluid exhausted from outlet 16 may be passed through a heat exchanger (not shown) and restored to ambient or near-ambient temperature before being again pumped into inlet 14. In an open-loop system, such as when air is used as the operating fluid, the fluid is simply discharged at outlet 16 and appropriately dispersed.

Air cooling is preferred since it eliminates the mass of the circulating liquid and the additional components required of a circulating system. But the heat transfer coefficient (h) of air is only 1/10 or 1/20 that of a water-based fluid. By Fourier's Law, the rate of heat loss \dot{Q} in a channel containing a flowing fluid is given by:

\dot{Q}=−h.AΔT Eq. 1
where A is the channel surface area and
ΔT is the temperature difference between the cooling fluid and the channel wall.
   Thus, the rate of heat extraction for a fluid is substantially greater than for air for like cooling channel geometry.

It is clear, however, that an increase in ΔT may offset a reduced h. It is an object of this invention to enable high performance air cooling facilitated by a thermoelectric assembly functioning as a heat pump. Such a heat pump will serve to increase ΔT, and so will enable controlled cooling or heating of battery cells and/or modules using air, by increasing the efficiency with which heat may be extracted from the battery.

FIG. 1B shows, in layered cut-away, a module incorporating such a thermoelectric assembly. Module 12 contains a number of pouch cells 20 which are stacked and positioned to closely fill the interior volume of the module housing 19. Each of pouch cells 20 is encased in a flexible polymer-based pouch 17 sealed at its edges 15. Each of pouches 20 contains at least one cell comprising a negative current collector 21, a positive current collector 23, the current collectors being separated by an electrically non-conductive separator 22 and immersed in an electrolyte (not shown). Each of current collectors 21, 23 is connected to its respective tab 25, 24 and each of the plurality of respective tabs is interconnected. Interconnection as depicted here results from attaching each of the individual tabs to a common respective bus bar, bus bars 27 and 26, but such a construction is merely illustrative and other configurations may be adopted without limitation. In turn, each of bus bars 27, 26 is connected to a corresponding post connector 29, 28 which passes through module housing 19 to enable external connection to the cells.

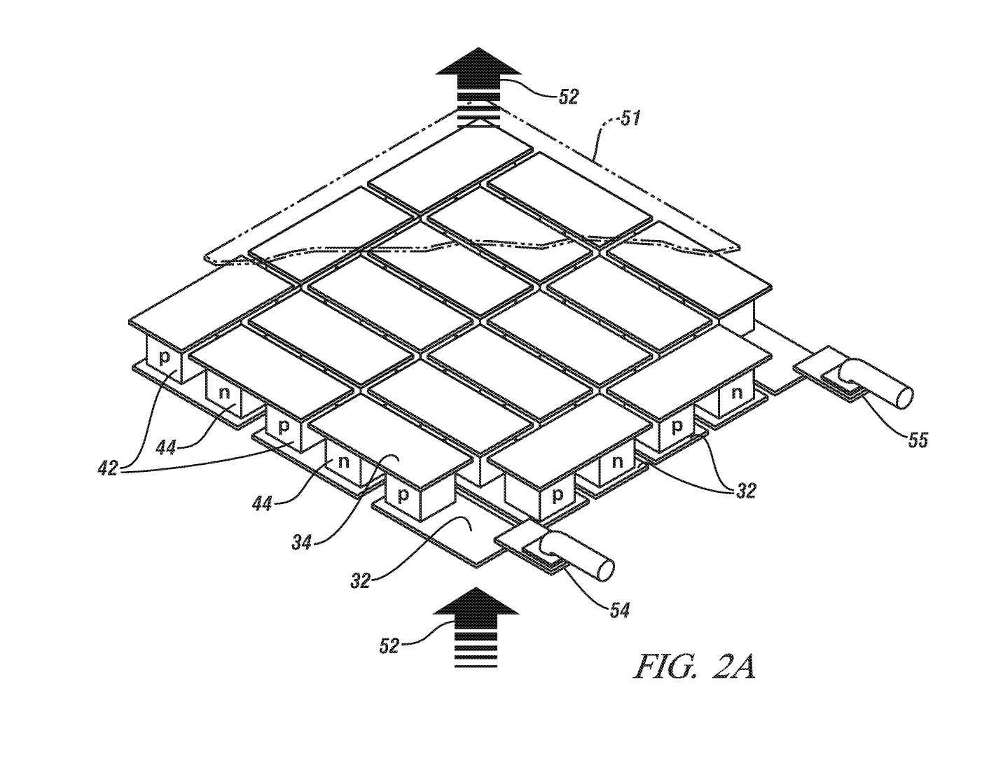

An array of spaced apart electrical interconnects 32 is positioned in contact with face 56 of housing 19. Thermoelectric elements 42 and 44, which may be alternating p-type semiconductor thermoelectric elements (42) and n-type semiconductor thermoelectric elements (44), are positioned on interconnects 32 so that a first face of each of the thermoelectric elements is in electrical contact with the interconnect. Overlying the thermoelectric elements and in electrical contact with a second face of the thermoelectric elements is a second electrical interconnect 34. Interconnects 32 and 34 are so arranged as to enable series connection of all the thermoelectric elements and enable a continuous electrical circuit between external electrical contacts 54, 55 as is shown more clearly in FIG. 2A. The thermoelectric assembly may be positioned on one or both of opposing faces 56 of the module housing and may be located on some or all of the modules 12 making up battery 10 as shown in FIG. 1A.

FIG. 2A shows the thermoelectric assembly of FIG. 1B in greater detail, clearly illustrating the alternating array of p-type and n-type thermoelectric elements and better showing how the interconnects 32, 34 cooperate to ensure serial connection of the thermoelectric elements. Shown in ghost is a substrate 51 in contact with, and adhering to, the surface of interconnect 34 not in contact with the thermoelectric elements. Substrate 51 is optional when the thermoelectric elements are mounted on a rigid substrate such as module wall 56 but are necessary for structural stability if the thermoelectric array of this embodiment is mounted on a flexible substrate such as a pouch wall.

FIG. 2B illustrates a conventional commercial thermoelectric heater/cooler, 40. In such a device supporting substrates 48 and 51 are employed, one attached to each of interconnects 32 and 34. These substrates 0.3 to 0.8 millimeters thick are commonly made of electrically non-conductive ceramic, often Al₂O₃ or AlN. These ceramic substrates thus introduce a thermal barrier between the thermally-managed object and the thermoelectric elements and so reduce the efficiency of the thermoelectric device.

Passing direct current electricity through the assembly will induce a temperature gradient and enable heat flow, here indicated, on both of FIGS. 2A and 2B, by arrows 52 from one face of the thermoelectric elements to the other. Thus, by placing one surface of the thermoelectric assembly, say surface 57 (FIG. 2B) of substrate 48 in thermal contact with a body (not shown) heat may be extracted from the body and transported to surface 50 of substrate 51 for subsequent transfer to a suitable fluid medium and eventual discharge. It will be appreciated that the direction of heat flow may be reversed upon reversing the direction of current flow by reversing the polarity of the connections.

The magnitude of the temperature gradient which may be maintained across a thermoelectric element depends on the current passed through the assemblies. Typically a maximum temperature differential of up to about 80° C. may be established at maximum current draw for a thermoelectric assembly based on a bismuth composition. However, the best balance between temperature differential and rate of heat extraction obtains at a lower temperature differential of about 40° C. So, if the ‘cold’ side of the thermoelectric assembly is maintained at the preferred battery operating temperature range of between 25° C. and 35° C., the hot side of the assembly will be at a temperature of between 65° C. and 75° C. Again however, note that in conventional thermoelectric devices (FIG. 2B), each of substrates 48, 51 will sustain a temperature gradient through their thickness. Hence in substrate 48, for example, surface 57 will be at a higher temperature than surface 53.

If heat is to be transferred from the hot side of the assembly to flowing air, the increased temperature differential enabled by the thermoelectric heat pump suggests, by Equation 1, an increase by a factor of about 4 to 9 in the rate of heat loss to the flowing air. This increase partially compensates for the lower value of the heat transfer coefficient of air relative to water, and with only a modest increase in the channel area permits air cooling even for high output batteries. Of course, the use of such thermoelectric heat pumps is advantageous even if liquid cooling is preferred, since the improved efficiency enabled by such heat pumps would also enable smaller diameter liquid cooling lines and so reduce the total coolant mass.

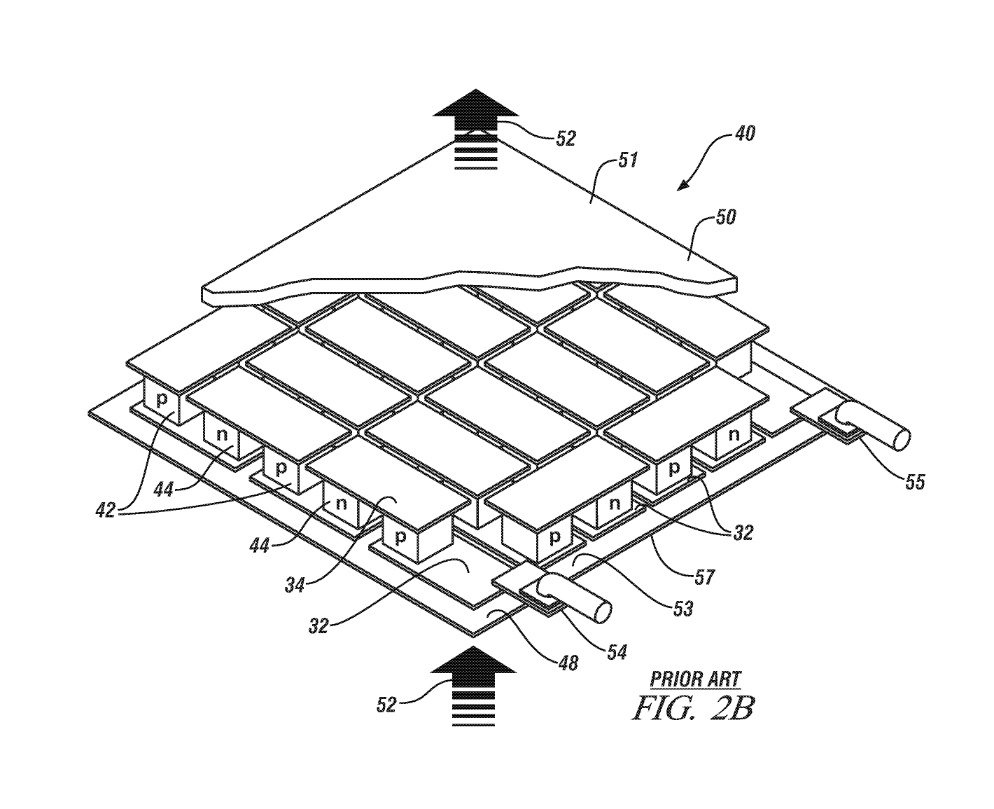

FIG. 3A illustrates, in fragmentary sectional view, two representative configurations for a battery module in thermal communication with a thermoelectric heat pump. Battery module 60 (details not shown) is enclosed within housing 62. Housing 62 is shown in some portion with metal module housing wall 56 and in some portion with polymer module housing wall 56′. In some battery embodiments module housing wall 56′ may be a moldable polymer. The electrically non-conductive character of polymers permits of embedding thermoelectric elements 42, 44 and one of their associated conductive pads 46 in the polymer module housing wall 56′. This approach simplifies installation of the thermoelectric elements and serves to minimize thermal gradients. It will be appreciated that the battery cells comprising battery module 60 are contained within pouches or similar containers as shown in FIG. 1B so that there is no possibility of reaction between the cell electrolyte and any of thermoelectric elements 42, 44 or conductive pad 46. In the portion of module 60 with polymer wall 56′ the thermoelectric elements are connected at their second faces by conductive pad(s) 46′ but no substrate, such as 51 in FIGS. 2A and 2B is employed.

But, the module housing wall may also be made of a metal, for example, aluminum. Such a metal housing wall 56 forbids embedding the thermoelectric elements since the metal wall will conduct electricity and interrupt the orderly flow of current from one thermoelectric element to the next. In this circumstance, the thermoelectric elements 42, 44 and their associated conductive pads 46 may be secured to wall 56 using a two-sided adhesive polymer film selected to have good electrical insulating properties as shown in FIG. 3B. The film 156, which may suitably be a polyimide, is coated on each side with coextensive adhesive layers 154, 158. Suitable adhesives include silicones and acrylics. Adhesive layer 154 bonds the thermoelectric elements to the face of wall 56 and film 156 electrically isolates wall 56 from the thermoelectric elements 42, 44. So, wall 56 may, in addition to retaining the pouch cells, serve the same function as plate 48 (FIG. 2B). Thus as shown in FIG. 1B, the thermoelectric assembly may be integrated with the (battery) module, eliminating the need for the separate, heat-transfer inhibiting, non-conductive substrate 48 (FIG. 2B). As shown, a ‘substrate’ comprising planar regions 65 and upstanding regions 67 may serve a similar purpose as second substrate 51 or may be entirely or selectively eliminated as shown in conjunction with the configuration shown at wall 56′.

Suitably the polyimide layer may range from about 13 to 25 micrometers in thickness while the adhesive layers may be about 20 micrometers thick. The elimination of substrates 48, 51 serves to reduce temperature gradients and improve the performance of the thermoelectric assembly. If the module wall is electrically non-conductive only adhesive is required. Again, silicone or acrylic adhesives at a thickness of about 20 micrometers or so may be used but low surface energy polymer surfaces, for example PET, polypropylene, thermoplastic polyolefins (TPOs) and polyethylene, may require a plasma or chemical pre-treatment to obtain suitable adhesion. Mounting frame 26 (FIG. 1A) in addition to securing the battery modules will, by applying pressure, facilitate good adhesion and thermal contact between the thermoelectric assembly(ies) and the battery module(s). Direct electrical current is conveyed to the thermoelectric assembly at electrodes 54, 55, suitably insulated from walls 62 by insulators 354, 355, and passes through each of p-type 42 and n-type 44 thermoelectric elements facilitated by electrically conductive pads 46, 46′.

A similar scheme, shown at FIG. 3C is employed to secure the thermoelectric assembly to a surface of housing end closure 64, which may again be metal and which functions as the second substrate for the thermoelectric assembly. This approach advantageously overcomes the issues of the thermal gradients established through conventional ceramic substrates. Also, housing end closure 64 may have a shaped exterior surface, for example comprising recesses 65 and fin-like protrusions 67, for enhancing heat transfer from end closure 64 to an adjacent fluid as described in greater detail below.

By application of a suitable electric current and voltage, a temperature differential may be developed between the opposing ends of the thermoelectric elements in order to develop a preferred temperature differential between the face of wall 56 and housing end closure 64. Thus heat from battery module 60 may be conveyed to recessed surface 65 and projections 67 of end closure 64.

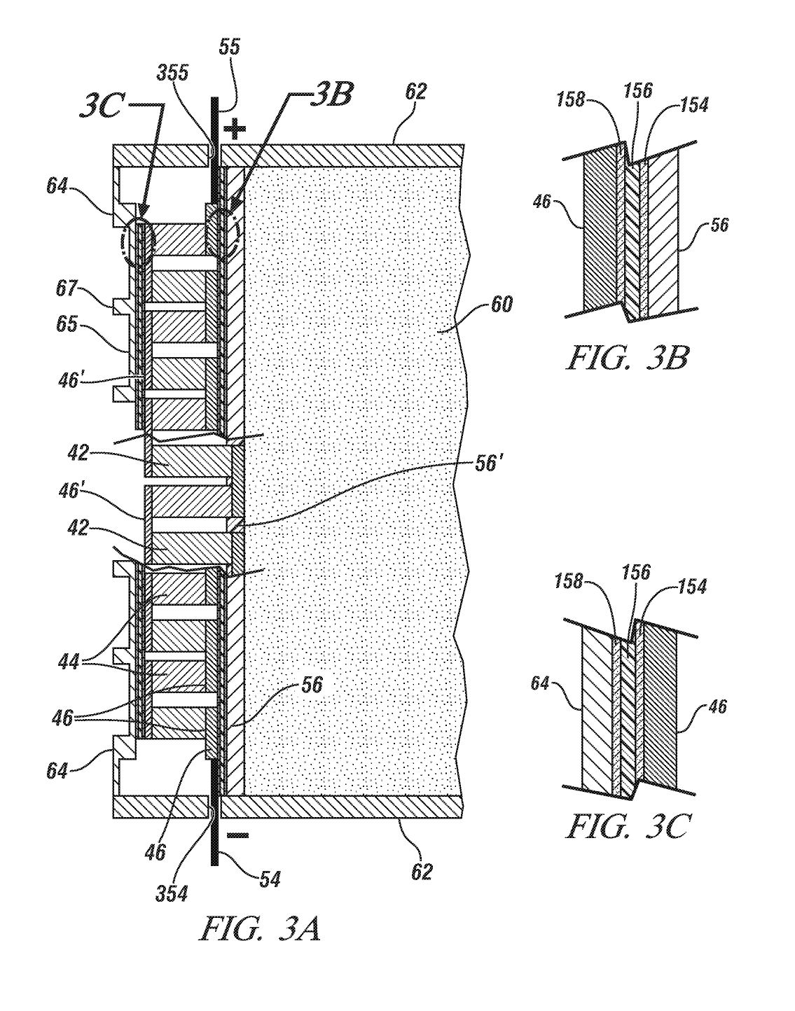

FIG. 4 illustrates, in cross-section two of the battery module units with thermoelectric elements shown in FIG. 3A. For simplicity the details of the attachment of the thermoelectric elements are not shown in FIG. 4 but the adhesive or adhesive-coated insulating tape approach described in connection with FIG. 3 is equally applicable to the arrangement shown in FIG. 4. The modules shown in FIG. 3 have however been adapted to include further features intended to both secure them together and enable powering the thermoelectric elements of battery units from a splittable busbar. End closures 64 and 64′ may again serve the function of substrate 51 of FIGS. 2A and B as well as establish a suitable geometry for transfer of heat from the thermoelectric assembly to a fluid. As modules 60, 60′, shown in spaced-apart configuration, are brought into contact, their corresponding end closures 64, 64′ form a series of channels 78 extending into and out of the plane of the paper and through the thickness of the module. Channels 78, bounded by recessed surfaces 65, 65′ and by projections 67, 67′, are integral to the battery assembly rather than the separate heat management system shown in FIG. 1. Thus, for example, air may be directed along each of channels 78, for example by a fan, to enable forced convection and exhaust the heat transported to end closures 64, 64′. A recirculating water-based fluid may also be used but additional gasketing and sealing features (not shown) may be required to ensure that no leakage of cooling fluid occurs. It will be appreciated that the depiction of end closures 64, 64′ is illustrative and not limiting and their design may be modified as required to achieve any preferred design for channels 78 or any other suitable configuration. For example, end closures 64, 64′ may incorporate additional non-contacting ribs or other geometric features intended to promote turbulent flow and/or more efficient heat transfer.

Engagable features 70, 72 are intended to temporarily secure modules 60, 60′ together while permitting them to be disengaged at some future time if required. Compliant arm 70 may, as modules 60, 60′ are advanced together, be elastically deformed and deflected away from housing 62 by engagement of ramp 75 with ramp 73 of locking feature 72. On continued advancement, engagement feature 75 on the extremity of compliant arm 70, urged by the elastic stored energy of compliant arm 70, engages complementary recess 74 in locking feature 72, securing the modules together. Features designated 70′, 72′, 73′, 74′ and 75′ enable the modules to be similarly secured at a second location, and if required, yet further locking features, of similar or alternate design may also be included. These locking engagement features may replace or supplement the constraints imposed by locking frame 18 (FIG. 1) and further assure good thermal contact between the thermoelectric assembly and the battery components.

Also shown in FIG. 4 is a pair of split busbar assemblies with insulated (insulation not shown) wire conductors 154, 254 integrated into housing 62. Each of conductors wire conductors 154, 254 terminates on one end in a socket 155, 255 recessed into housing 62, and on its other end a conductor section 154′, 254′ which protrudes beyond housing 62. Thus as the housings of 62 of modules 60, 60′ contact and the engagement features engage, protruding sections 154′, 254′; will engage with sockets 155, 255 to form a continuous busbar between the two modules. Current may be conveyed to and from busbars 154′ and 254′ by connections 54 and 54′ which are suitably connected to power the thermoelectric assembly and accomplish the desired temperature management. It may be noted that the configuration shown has been error-proofed so that it is impossible to assemble the modules improperly and reverse the electrical connections to the thermoelectric assemblies.

The use of a bus bar simplifies the electrical connections to the thermoelectric assemblies associated with specific cells/modules but may limit or eliminate opportunity to vary the cooling capability of individual thermoelectric assemblies to address any non-uniform temperature distribution within the battery volume. If temperature variation within the battery is excessive, it may be necessary to employ individually-wired thermoelectric assemblies like that shown in FIG. 3A. But for lesser, and more systematic temperature variation it may be preferred to assemble and bulbar several modules into a group and then assemble the battery from these groups so that group-to-group temperature variation may be independently addressed.

Although the application of the invention has been described with regard to battery modules packaged in electrically-conductive metallic housings, it will be appreciated that it may be readily applied to electrically non-conductive module housings. In addition the invention has application to individual prismatic soft-sided, or pouch, cells where the outermost layer of the pouch is a polymer. The major difference in these situations is that the thermoelectric elements and connectors may be adhesively bonded directly to the module wall since the bonding surface of the module or cell is electrically non-conductive. However, if the pouch or housing has a low surface energy polymer bonding surface, such as PET, for example, some surface treatment, chemical or plasma may be required to render a suitably receptive surface for the adhesive.

It will be appreciated that a module, or, more properly, a module housing, will generally have opposing faces, often rectangular or polygonal in shape, bounded on their perimeters by a substantially continuous narrow strip of material to form a thin slab-like member as depicted in the exemplary embodiment of FIG. 1. Module housings will be positioned with their faces in contact as shown in FIG. 1 and so for maximum cooling the thermoelectric assembly should be generally coextensive with the module housing faces. Modules may be cooled from one or both faces as shown in FIG. 4. Here, face 80′ of module 60′ has an associated thermoelectric cooler so that module 60′ may be cooled from two sides. However face 80 of module 60, by contrast is in direct contact with module 160 and so is cooled from only one side. The face opposing face 80 of module 160 (not shown) could incorporate thermoelectric cooling to, like module 60, enable one-sided cooling. Such one sided-cooling, if sufficient to meet the thermal needs of the battery, may facilitate battery assembly since two modules may be fixedly attached reducing the number of cell or module units to be handled and assembled.

No matter how implemented however, the overall configuration of the battery would be that of a plurality of slab-like modules stacked with their housings in face-to-face contact with at least a thermoelectric cooling module selectively interposed between the abutting faces of two module housings and provision for passing a cooling fluid over a side of the thermoelectric cooling assembly.

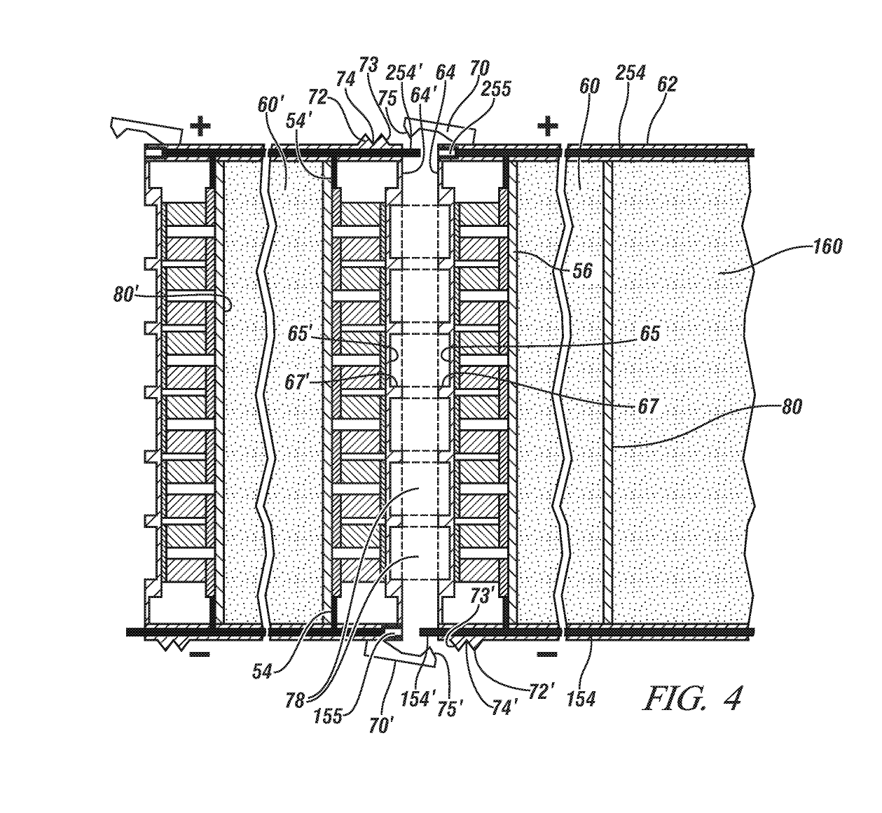

Alternative embodiments of the invention suitable for use with soft-side cell pouches are shown in FIGS. 5, 6 and 7. A wall fragment of a cell 300 adapted for thermoelectric cooling according to the practices of this invention is shown in FIG. 5. As commonly practiced, the wall comprises three polymer layers. A first layer, often of polypropylene, of a thickness of between 50 and 100 micrometers, in contact with the electrolyte. This first layer is overlaid by a second polymer layer, often comprising nylon, which is itself overlain by a third polymer layer, commonly of PET. The second and third layers are generally a few tens of micrometers, say 10-30 micrometers in thickness. This conventional scheme is adapted to the modified pouch wall structure incorporating a thermoelectric cooler shown in FIG. 5.

First polymer layer 302, in contact with the cell electrolyte is conventional. But overlaid on first polymer layer 302 are a number of discrete spaced-apart electrodes 310. The electrodes may be either copper- or aluminum-based and will generally have a thickness of about 40 micrometers and extend laterally between alternating p-type and n-type thermoelectric elements 316 and 318. Each of electrodes 310 and thermoelectric elements extend longitudinally to substantially the extent of the pouch dimension, here shown as I′. The thermoelectric elements 316, 318 also extend longitudinally the length of the pouch dimension, ‘L’, but have much lesser lateral and vertical dimensions, so that they have the form of prismatic elongated rods. The thermoelectric elements are arranged in closely spaced pairs 315. These pairs are spaced apart by a distance comparable to the lateral extent ‘d’ of the thermoelectric element pair. A layer of electrically and thermally insulating foam 314 is overlaid on the electrodes 310 and around the thermoelectric elements. The foam may be shaped to impart a tapered or sloped wall to that region of foam in contact with the exterior surfaces 317, 319 of the elements.

Bridging the gap between the elements 316, 318 of an element pair 315, and supported on insulating foam 314 is electrode 312. Thus the combination of electrode 310, thermoelectric elements 316, 318 and electrode 312 enables a continuous electrical circuit setting up, as before a temperature gradient between the ends of the thermoelectric devices. As in a conventional pouch wall, this structure is overlaid by two thin polymer layers 304, 306, producing a pouch wall geometry consisting of parallel alternating ridge-like 322 and valley-like 324 features. A cooling fluid may directed and channeled along the length of the thermoelectric structures as indicated by flow arrow 320.

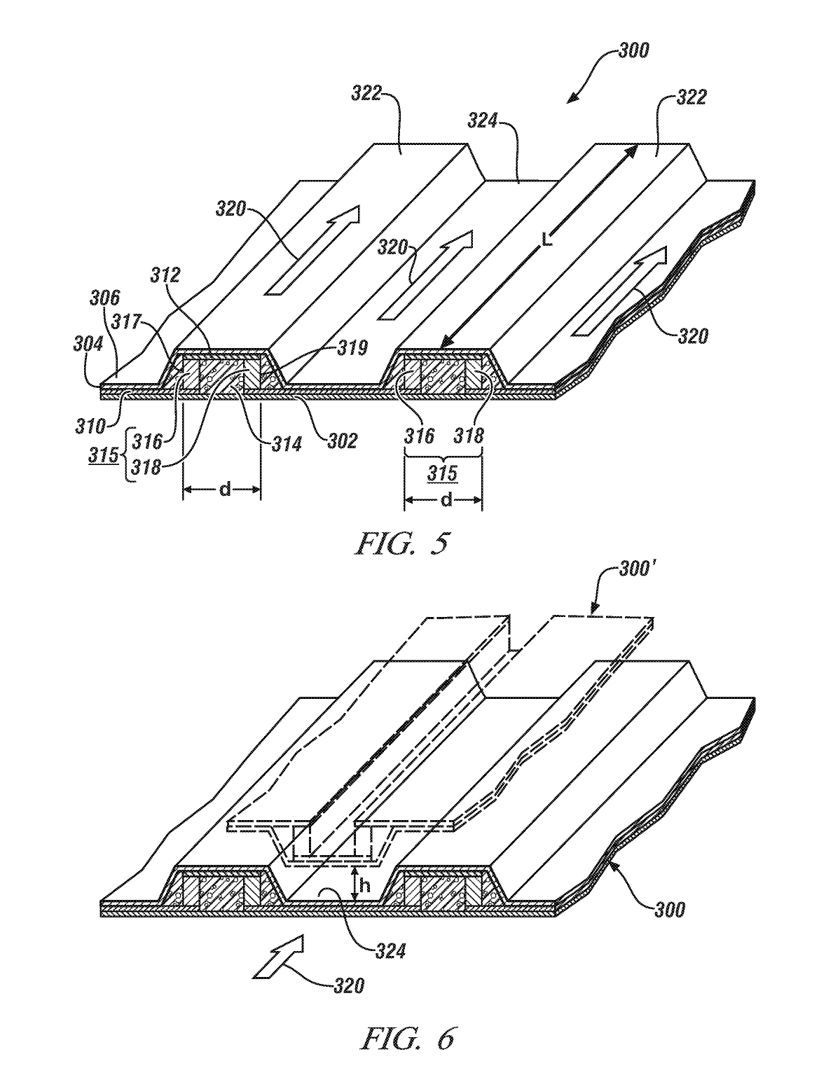

In operation, pouches may be placed in a module housing, somewhat constrained by the module housing walls and in intimate contact with other pouches in the housing. Unlike module housings which may incorporate locking and alignment capabilities like those previously described, soft wall pouches generally lack any locating or positioning features. However the ‘ribbed’ structure of the pouch walls shown in FIG. 5 provides opportunity for mechanical interference between abutting pouches. This may be exploited to locate the pouches in a compact arrangement which will yet enable free passage of cooling fluid as shown in FIG. 6.

FIG. 6 shows, portions of two contacting pouch walls positioned so that the ridge 322′ of a second pouch 300′ (shown in ghost for clarity) engages valley 324 of first pouch 300. The respective shapes and dimensions of the ridge and valley are selected so that full engagement does not occur, leaving a gap ‘h’ between the peak of the ridge and the floor of the valley. This gap enables cooling fluid flow 320 access to the walls of pouches 300 and 300′. Cooling flow 320 may thus remove heat transported from the ends of the thermoelectric elements in contact with the first polymer layer of the cell wall to the end forming the ridge.

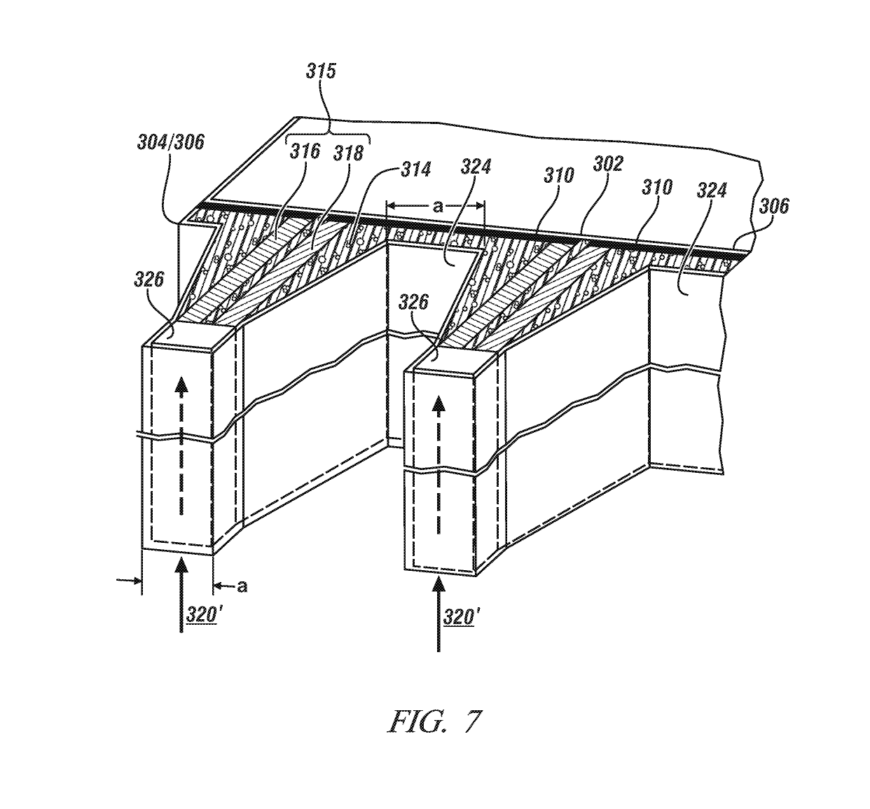

A derivative pouch wall structure is shown in FIG. 7. As before a pair 315 of thermoelectric elements 316, 318, substantially encased in shaped electrically and thermally insulating foam 314, are positioned with one end in contact with spaced apart electrodes 310 positioned on first polymer layer 302. However the second ends of the thermoelectric elements are in contact with rectangular tube 326. Rectangular tube 326 is electrically conductive and completes the operating electrical circuit for the thermoelectric device and also channels fluid, shown as flow 320′ directly past the second end of the thermoelectric elements. By setting the tube 326 exterior dimension, shown as ‘a’, equal to the recess 324 width, also shown as ‘a’, two pouches may fit tightly together and exclude fluid flow except through tubes 326. As before, these elements are overlaid by two polymer coatings, here shown as composite coating 304/306. In this example the shaped insulating foam 314 has been more generally distributed than in the prior example. Particularly the foam extends into planar recesses 324 where it may compliantly accommodate minor pouch-to-pouch dimensional variation and facilitate pouch to pouch engagement to form a compact assembly.

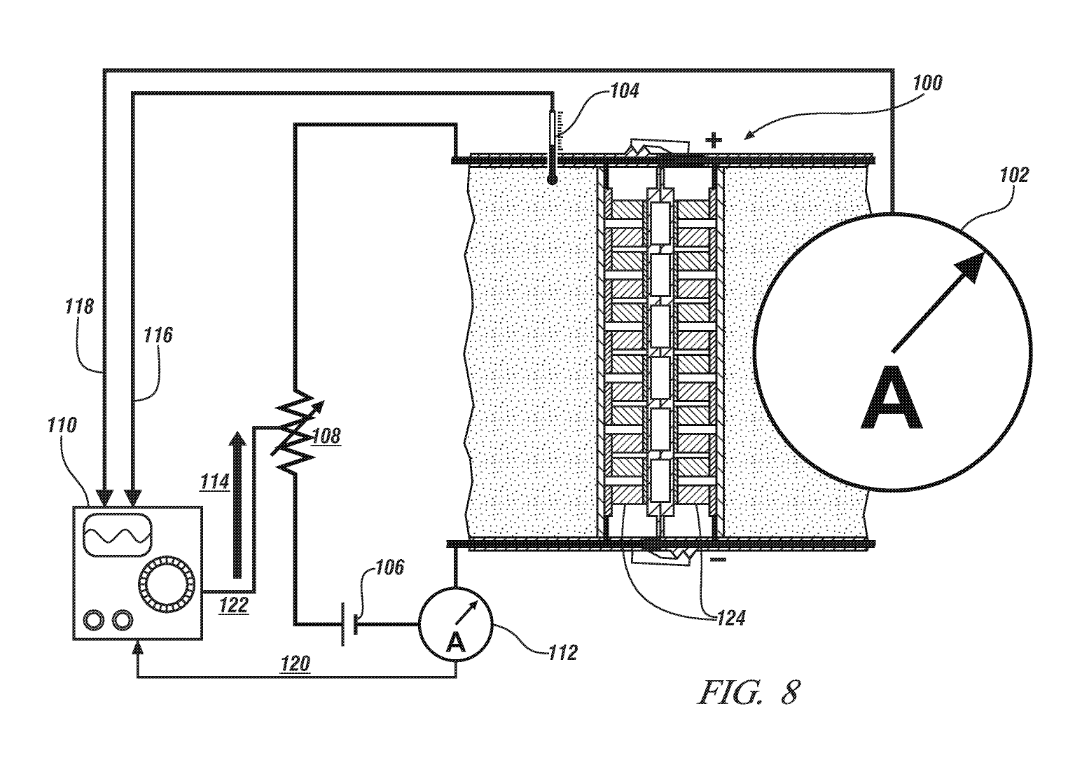

A scheme for controlling the temperature of a high voltage high current battery is shown in FIG. 8. In an exemplary embodiment the battery is a traction battery 100 for powering at least an electric motor in a vehicle and the controller 110 is located on board the vehicle. Traction battery 100 is in thermal communication with, and may be cooled by, a plurality of thermoelectric assemblies 124. Controller 110 accepts multiple inputs which may include: the traction battery temperature from sensor 104; the current draw from the traction battery from ammeter 102; and the current, measured by ammeter 112, powering the plurality of thermoelectric assemblies 124. The sensors may be any sensor suited for measuring the parameter of interest and representing the measurement as an electrical signal interpretable by controller 110. For example, suitable temperature sensors may include thermocouples, thermistors or platinum resistance thermometers among others.

Alternatively the thermoelectric devices themselves may serve as temperature sensors. Thermoelectric devices may operate as thermocouple. The voltage drop across a thermoelectric element when it is driven by an external current includes both an ohmic (resistance heating) contribution and a Peltier (thermoelectric cooling/heating) contribution. By switching off the external power only the Peltier contribution may be may be recorded. Because of the temperature gradient in the thermoelectric element the Peltier voltage will decay with time. The relevant Peltier voltage is that voltage at the time the thermoelectric element was disconnected from the external power source. This may be determined by extrapolation.

The Peltier voltage is proportional to the temperature difference between the cold and heated ends of the thermoelectric element. For the thermoelectric element closest to the cooling air inlet the cold end of the element will be at substantially ambient temperature and so, knowing the ambient air temperature, the battery temperature may be estimated. If desired, the temperature of the cooling air downstream of the inlet may also be estimated using a downstream thermoelectric element. Again a temperature difference may be estimated but here the cooling air, heated by passage over upstream thermoelectric elements, will be at some elevated temperature relative to ambient temperature. But, by assuming the battery temperature, estimated from the inlet thermoelectric element, is constant, the cooling air temperature may be estimated. An excessive cooling air temperature downstream of the inlet may signal a need to increase the flow of cooling air to maintain the batter temperature within acceptable limits.

As depicted, communication between controller 110 and these sensors is effected by wired connections 116, 118, 120 but wireless, optical or other communication means may be employed without loss of generality. Controller 110 may respond to at least battery temperature and thermoelectric assembly current inputs to communicate control signal 114 through connector 122 to current adjuster 108 to control the thermoelectric current supplied by direct current power source 106. While in many vehicle applications direct current power source may be a nominally 12 volt battery intended to power vehicle accessories, it will be appreciated that in some implementations, including vehicle applications, traction battery 100 may also serve as power source 106. Control may be effected using a system model or using a model-independent control scheme such as a proportional control, proportional-integral (PI) control or proportional-integral-differential (PID) control among others. Knowledge of the instantaneous traction battery 100 current draw 102 may enable some look-forward control strategies to supplement the error-cancellation approach of PID control and other control strategies to minimize temperature overshoot and electric cooling current demand. It is anticipated that all modeling, if used, and computational tasks relative to the above control tasks, no matter how implemented, may be performed by controller 110, but supplementary computing devices may be employed as necessary. Monitoring and control may be performed continuously or data may be sampled, at, typically regular intervals, which enable matching the response time of the controller with the expected rate of change in battery temperature. Typically a sampling rate of between 1 and 5 samples per second is suitable.

The most significant requirement for thermoelectric assemblies 124 will be to limit the maximum battery temperature to within its preferred temperature range, but, in cold climates it may also be preferred to incorporate in the controller and battery 106 control hardware, provision for reversing the polarity of the current supplied to traction battery 100. With this capability, the locations of the hot and cold ends of the thermoelectric elements may be reversed so that the hot end is in thermal contact with the cell/module. Thus, cold batteries, say those at less than −10° C. or so, may be more rapidly warmed to their preferred operating temperature.

Because of the need to manage battery power, particularly in electric vehicles, such battery temperature management will normally only occur when the vehicle is being operated. But, there are climactic conditions where the battery temperature may exceed its preferred range even when parked. For example in deserts and other environments with high solar loads excessive battery temperatures may occur, particularly under high ambient temperature. In northern latitudes subject to extremely cold climates the battery temperature may fall below its preferred minimum temperature. In these circumstances a similar control strategy may be followed even though the traction battery is not in use. Typically any battery temperature management conducted when a vehicle is not in use would be highly conservative to appropriately trade off the dual goals of maintaining a high battery state of charge while maintaining the battery temperature in an acceptable range. Thus the threshold for initiating the battery temperature management procedure may be appreciably higher, than under operating conditions.

The above descriptions of embodiments of the invention are intended to illustrate the invention and not to limit the claimed scope of the invention.

1. An electrochemical unit for assembly with like units in making a vehicle battery, the electrochemical unit comprising:
a pouch comprising at least one set of electrodes and an electrolyte, the pouch and its contents being shaped as a two-sided unit with opposing faces for generally face to face contact in assembly with like pouch units, the electrochemical unit requiring heating or cooling during its operation, each face of the pouch being defined by a first layer of a first polymer composition overlain by at least a second polymer layer of a second polymer composition, the first polymer layer being in intimate contact with the electrolyte and with at least an electrode; the electrochemical unit further comprising
a plurality of spaced-apart, like-shaped, alternating, n-type and p-type semiconductor thermoelectric elements, each with opposing first and second faces, the first faces of adjacent elements being electrically connected to form a first junction, the second faces of adjacent elements being electrically connected to form a second junction, the first and second junctions being arranged to enable serial connection of the plurality of elements, the elements and their associated junctions being generally co-extensive with, supported by, and attached to the first polymer layer to form an assembled thermoelectric device integral with the pouch structure, the device being activatable by passage of direct electric current to produce a cooling or a heating face in contact with the pouch face;
the thermoelectric device being substantially covered by the second polymer layer.

2. The electrochemical unit of claim 1 further comprising a shaped insulating layer positioned between the first polymer layer and the at least one overlying polymer layer, the overlying polymer layer conforming to the surface form of the shaped insulating layer so that the pouch face is suitably contoured for engaging with the face of a like unit for assembly into a vehicle battery.

3. The electrochemical unit of claim 2 in which the insulating layer comprises a polymer foam.

4. The electrochemical unit of claim 2 in which the pouch face is so contoured as to form at least a channel, continuous across the pouch face, when two pouches are placed in face to face contact during assembly into the vehicle battery.

5. The electrochemical unit of claim 1 in which the pouch faces are generally rectangular and bounded by pairs of opposing edges and the thermoelectric units are elongated rectangles which lie generally parallel to a first pair of opposing edges and have a length sufficient to substantially extend from a first edge of the second pair of edges to a second end of the second pair of edges.

6. The electrochemical unit of claim 5 in which the first junction is supported on the first polymer layer and the electrical connection for the second junction is formed by positioning a plurality of electrically conductive hollow members in contact with the second faces of each of the adjacent thermoelectric elements, the hollow members having a length substantially equal to the length of the thermoelectric units.

7. A module for assembly with like modules in making a vehicle battery, the module having capability for cooling or heating the module, the module comprising:
a substantially closed housing containing at least an electrochemical unit comprising a pouch containing electrodes and an electrolyte, the electrochemical unit being adapted to receive, store and discharge electricity on demand, the module housing being shaped as a two-sided unit with co-extensive opposing faces for generally face to face contact in assembly with like modules, the housing faces each having a thickness and an interior and an exterior surface, the faces having a perimeter, the faces being joined to a strip with edges, with each strip edge being attached to one of the face perimeters of the opposing faces to define the housing; and
a plurality of like-shaped, spaced-apart alternating p-type and n-type semiconductor thermoelectric elements with opposing first and second faces, the first faces of adjacent elements being electrically connected to form a first junction, the second faces of adjacent elements being electrically connected to form a second junction, the first and second junctions being arranged to enable serial electrical connection of the plurality of elements, the elements and their associated junctions being generally co-extensive with, supported by and attached to a face of the housing to form an assembled thermoelectric device integral with the module housing, the device being activatable by passage of direct electric current to produce a cooling or a heating face in contact with the module face.

8. The module of claim 7 in which the thermoelectric device is adhesively attached to the exterior surface of a housing face.

9. The module of claim 7 in which the thermoelectric device is attached by embedding the device in a housing face.

10. The module of claim 9 in which the first junctions of the device are coplanar with the interior face of the module and in thermal communication with a pouch face.

11. The module of claim 7 in which the first junction of the device is in thermal communication with the module and the second junction is in thermal communication with a flowing fluid.

12. The module of claim 11 further comprising a structure attached to the second junction to promote enhanced heat flow.

13. The module of claim 12 in which the structure to promote enhanced heat flow comprises fins.

14. The module of claim 7 in which the faces of abutting modules are adapted to form passages for flow of fluid across their faces when the abutting module faces are brought into contact.

15. The module of claim 7 in which the modules further comprise latching devices for releasably securing abutting modules in face to face contact.

16. The module of claim 7 in which the modules further comprise an electrical bus bar to convey electricity for powering the thermoelectric array from a first module to an abutting module.

17. The module of claim 7, the module further comprising a temperature sensor.

18. The module of claim 17 in which the temperature sensor is one or more of the thermoelectric elements.

19. A battery comprising a plurality of modules as recited in claim 14, at least one of the modules comprising a temperature sensor, the modules being secured in face to face relation and suitably electrically interconnected to deliver electrical power at a predetermined current and voltage.

20. The battery of claim 19 further comprising inlet and outlet passages to enable flow of ambient air across at least a module face comprising a thermoelectric device.
